(19) United States
(12) Patent Application Publication
(10) Pub. No.: US 2009/0054298 A1
(43) Pub. Date: Feb. 26, 2009

(54) Thickening surfactants for acidic solutions

(76) Inventor: Stephen F. Gross, Souderton, PA (US)

Correspondence Address: FOX ROTHSCHILD LLP, 1101 MARKET STREET, PHILADELPHIA, PA, 19107, US

(21) Appl. No.: 11/895,123

(22) Filed: Aug. 23, 2007

(51) Int. Cl. C11D 1/90

(52) U.S. Cl. 510/535

(57) ABSTRACT

The invention is a thickened aqueous acid solution wherein the thickener is an aliphatic or alicyclic betaine of the formula

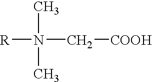

in which R is a saturated or unsaturated aliphatic of alicyclic group containing from 12-30 carbon atoms. The aliphatic group can be straight chain or branched. The betaine is present in a range of from 1.0% to 15% by weight of the acid solution. The acid solution has a pH of less than 3 and a concentration of the acid from 4% to 20% by weight of the solution.

### CROSS REFERENCE TO RELATED APPLICATIONS

Not applicable.

### FIELD OF THE INVENTION

The invention is a thickening surfactant for acidic solutions. The surfactant is an alkyl betaine which is effective in thickening acidic solutions.

### BACKGROUND OF THE INVENTION

It is well known in the art that acidic solutions present a difficult problem in regard to increasing the viscosity (thickening). Many surfactants and thickening agents hydrolyze in strong acid solutions and lose their surface activity over time, causing product instability, syneresis or separation. Many traditional thickeners, however, are ineffective in strong acidic solutions due to stability/compatibility problems. HCl solutions are particularly difficult to thicken.

### BRIEF DESCRIPTION OF THE INVENTION

Applicants have unexpectedly discovered that alkyl betaines of a formula

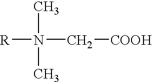

wherein R is an aliphatic or alicyclic group containing from about 12 to 30 carbon atoms, preferably from 14 to 24 carbon atoms and most preferably from 16 to 22 carbon atoms which group can be saturated or unsaturated, and the aliphatic group can be straight chain or branched. The aliphatic and alicyclic betaines are effective thickeners for acidic compositions in a pH range below 3 and preferably below 2.5 and most preferably below 2.

The aliphatic and alicyclic betaines can be used alone or in combination. The aliphatic and alicyclic betaine thickeners of the present invention are particularly effective at concentrations in a range of from 1 to 10% by weight and preferably from about 2 to 6% by weight of the acidic compositions. The aliphatic and alicyclic betaines useful in the practice of the present invention not only thicken the acidic composition but also increase the wetting ability and effectively emulsify fragrance oils which can be included in the composition.

The thickened acidic composition of the invention is particularly useful where dilute acid solutions are utilized as cleaners for ceramic surfaces.

### DETAILED DESCRIPTION OF THE INVENTION

The aliphatic and alicyclic betaines useful in the practice of the present invention contain an aliphatic or alicyclic group containing from 12 to 30 carbon atoms and most preferably from about 16 to 22 carbon atoms. The aliphatic or alicyclic betaines are present in the acidic composition in a range of from 1% to 15% by weight of the composition and preferably in a range of from 2% to 10% by weight of the composition and most preferably in a range of from 2% to 8% by weight of the composition.

The acidic compositions are generally diluted acidic solutions containing up to about 20% by weight of acid and preferably in a range of 4 to 15% and most preferably 6 to 10% by weight of acid. The aliphatic and alicyclic betaines useful in the practice of the present invention are particularly useful for thickening hydrohalic acid solutions such as HCl solutions, sulfuric acid solutions, phosphoric acid solutions and organic acid solutions such as solutions of citric acid, glycolic acid, lactic acid and acetic acid.

The aliphatic betaines are effective as thickeners in acid solutions up to a concentration of the acid where the oxidizing power of the acid causes deterioration of the aliphatic or alicyclic betaines during storage of the composition.

In addition to thickening an acidic solution, the aliphatic and alicyclic betaines improve the wetting properties of the acidic solution and in addition can emulsify or solubilize fragrance oils which can be difficult to incorporate into aqueous solutions. In particular, the betaines useful in the practice of the present invention can solubilize oil of wintergreen which is known to be difficult to incorporate into aqueous systems.

In view of the thickening properties imparted to the aqueous acidic system, the improved wetting properties of the aqueous system and the ability to incorporate fragrance oils into the aqueous system, the formulation of ceramic cleaning compositions and in particular urinal cleaning composition can be readily accomplished by addition of an aliphatic or alicyclic betaine to an acid solution. The acidic cleaning solution of the present invention are particularly useful in removing mineral deposits from porcelain substrates.

PORCELAIN CLEANING COMPOSITION

| | % wt. |
|---|---|
| Water | 69.0-70.0 |
| Hydrochloric acid (37%) | 24.4 |
| Velvetex ® OLB-50 (50%) | 5.6 |
| Perfume oil (optional) | 0.0 to 1.0 |

The 9% by weight HCl solution had a viscosity of 400 cps at 23° C., and a static surface tension of 32.5 dyn/cm.

Velvetex® OLB-50 is 50% by weight solution of oleyl betaine.

As can be seen from the examples, the aliphatic betaine is a tri-functional additive particularly useful for acidic toilet bowl cleaners.

The acid compositions of the invention can also contain colorants which are acid stable to improve the aesthetic properties of the composition.

We claim:

1. A thickened aqueous acid composition which comprises:
(a) from 1.0% to 15% by weight of betaine of the formula 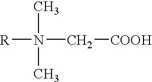
wherein, R is in alicyclic or aliphatic group which can be saturated or unsaturated and the aliphatic group can be straight chain or branched containing from 12 to 30 carbon atoms;
(b) an aqueous acid solution with a concentration of up to 20% by weight of acid and a pH below 3;
(c) water; and
(d) optionally, up to about 1% by weight of a fragrance oil, colorants and other constituents usually present in aqueous acid solutions.

2. The composition of claim 1 wherein the betaine comprises oleyl betaine.

3. The composition of claim 1 wherein the aqueous acid comprises HCl.

4. The composition of claim 2 wherein the oleyl betaine is present at from 2% to 10% by weight of the composition.

5. The composition of claim 1 containing from 4% to 15% by weight of the acid.

6. The composition of claim 5 containing from 7% to 10% by weight of the acid.

7. The composition of claim 4 containing from 2% to 8% by weight of the oleyl betaine.

8. The composition of claim 1 where the composition contains from 2% to 10% by weight of the betaine and from 4% to 15% by weight of the acid.

9. The composition of claim 8 containing from 6% to 10% by weight of the acid.
